(19) United States
(12) Patent Application Publication
(10) Pub. No.: US 2009/0240562 A1
(43) Pub. Date: Sep. 24, 2009

(54) BUSINESS IMPROVEMENT SUPPORT APPARATUS

(75) Inventors: Noriko Kohno, Minato (JP); Takashi Yamaguchi, Minato (JP); Yoshihiro Takada, Minato (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/350,692

(22) Filed: Jan. 8, 2009

(30) Foreign Application Priority Data
Mar. 21, 2008 (JP) 2008-074345

(51) Int. Cl. G06N 5/02; G06Q 10/00

(52) U.S. Cl. 705/10; 705/7; 706/52

(57) ABSTRACT

A business improvement support apparatus includes an achievement level calculation unit which calculates an achievement level in accordance with each of a plurality of evaluation indexes with respect to business in a predetermined period. A satisfaction level calculation unit calculates a customer satisfaction level with respect to the same evaluation index as the evaluation index in accordance with which the achievement level is calculated by the achievement level calculation unit. A detection unit detects a gap between the achievement level calculated by the achievement level calculation unit and the customer satisfaction level calculated by the satisfaction level calculation unit. A decision unit sets a target value in accordance with the evaluation index corresponding to the gap detected by the detection unit, and decides on specific itemized target values relevant to the evaluation index from the target values set in accordance with the evaluation index.

### CROSS-REFERENCE TO RELATED APPLICATION

This application is based upon and claims the benefit of priority of Japanese Patent Application No. 2008-74345, filed on Mar. 21, 2008, the entire contents of which are incorporated herein by reference.

### FIELD

The embodiments discussed herein are related to a business improvement support apparatus. Particularly, it relates to a business improvement support apparatus, which can fill a deficit in subjective valuation of corporate activity to thereby support business improvement adapted to market environment.

### BACKGROUND

As for general corporate activity, since a business budget for a predetermined period such as a fiscal year is set at the beginning of the period and a business result is obtained at the end of the period, performance in conducting business may be often evaluated by the level of achievement against the business budget. That is, since the level of achievement in the period, for example, against target quality, target cost, target delivery time, etc. set as values of the business budget at the beginning of the period is closely relevant to the corporate ability to conduct business, the ratio of a result value in a current business period to a budget value for the current business period can be used as an index for settlement of a next business budget or the like in consideration of the corporate performance.

The same way of thinking applies to project management support or the like. That is, in this case, a difference between a planned value for a project and an actual value in progress of the project is calculated, so that a project operating plan can be evaluated based on the calculated difference.

### SUMMARY

In keeping with one aspect of an embodiment, a business improvement support apparatus includes an achievement level calculation unit which calculates an achievement level in accordance with evaluation indexes with respect to business in a predetermined period. A satisfaction level calculation unit calculates a customer satisfaction level with respect to the same evaluation index as the evaluation index in accordance with which the achievement level is calculated. A detection unit detects a gap between the achievement level calculated by the achievement level calculation unit and the customer satisfaction level calculated by the satisfaction level calculation unit; and a decision unit sets a target value in accordance with the evaluation index corresponding to the gap detected by the detection unit, and decides specific itemized target values relevant to the evaluation index from the target values set in accordance with the evaluation index.

Additional objects and advantages of the embodiment will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1 is a sequence view showing a specific example of a business flow according to Embodiment 1;

FIG. 2 is a block diagram showing the configuration of the main part of a business improvement support apparatus according to Embodiment 1;

FIG. 3 is a block diagram showing the internal configuration of a validity analysis portion according to Embodiment 1;

FIG. 4 is a block diagram showing the internal configuration of a gap analysis portion according to Embodiment 1;

FIG. 5 is a flow chart showing operation of the business improvement support apparatus according to Embodiment 1;

FIG. 6 is a view showing a specific example of itemized target values according to Embodiment 1;

FIG. 7 is a view showing a specific example of a screen image according to Embodiment 1;

FIG. 8 is a view showing a specific example of business improvement according to Embodiment 1;

FIG. 9 is a view showing another specific example of business improvement according to Embodiment 1;

FIG. 10 is a block diagram showing the internal configuration of a gap analysis portion according to Embodiment 2; and

FIG. 11 is a view showing a specific example of micro analysis according to Embodiment 2.

### DETAILED DESCRIPTION OF EMBODIMENTS

One function of the invention is to calculate a gap between the level of achievement obtained from a budget value and a result value and the level of customer satisfaction obtained from customer evaluations, to thereby calculate each specific itemized target value in order to reduce the calculated gap. Embodiments of the invention will be described below in detail with reference to the drawings.

### First Embodiment

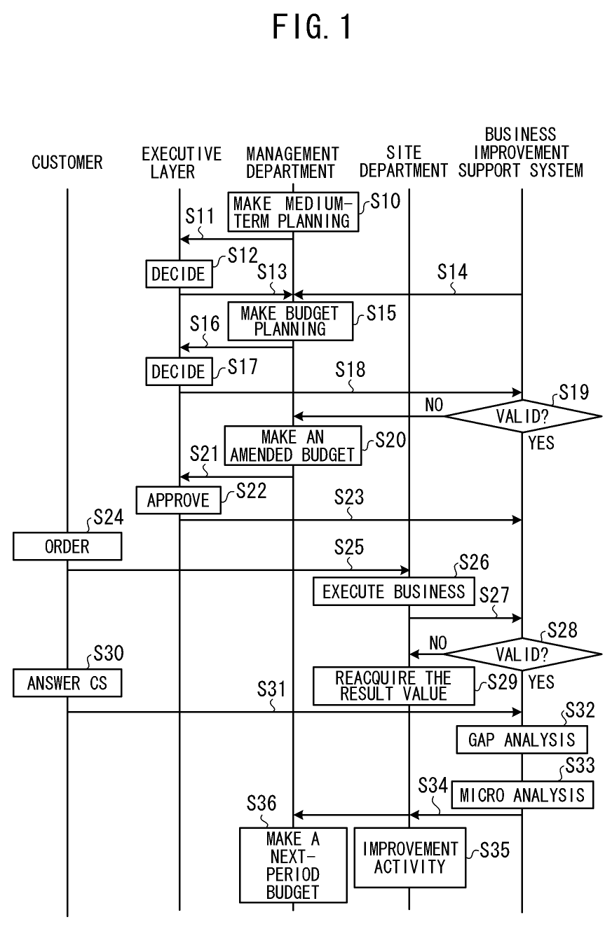

FIG. 1 is a sequence view showing a specific example of a business flow according to Embodiment 1 of the invention. The business flow shown in FIG. 1 is achieved by a customer layer, an executive layer, a management department layer, a site department layer and a business improvement support system. The executive layer, the management department layer, the site department layer and the business improvement support system except the customer layer belong to a corporation.

In a general corporation, when, for example, a medium-term plan such as a 3-year plan is made in the management department (step S10), the medium-term plan made thus is presented to the executive layer (step S11) so that the medium-term plan is decided by the executive layer (step S12). Then, the executive layer instructs the management department to make a budget plan in accordance with the medium-term plan (step S13), so that the management department collects past results from the business improvement support system (step S14).

When the management department makes a specific budget plan for a current business period based on past results in consideration of the medium-term plan (step S15), the management department presents the previously made budget plan to the executive layer (step S16) so that the executive layer decides the budget plan for the current business period (step S17). Respective budget values shown in the budget plan are sent to the business improvement support system (step S18) so that the business improvement support system judges whether each budget value is valid in a realistic and reasonable range or not (step S19). Here, the budget values sent to the business improvement support system are current-period target values concerned with evaluation indices such as a KPI (Key Performance Indicator) uniquely set by the corporation. Accordingly, when the budget values are comparatively widely different from result values or the like when considering the previous business period, the business improvement support system makes a decision that the budget values are not valid.

When the business improvement support system makes a decision that the budget values are not valid (No in step S19) the management department makes an amended budget (step S20) and presents the amended budget to the executive layer again (step S21). When the executive layer approves the amended budget (step S22), the executive layer sends the amended budget to the business improvement support system (step S23).

On the other hand, when the business improvement support system makes a decision that the budget values are valid (YES in step S19), the budget values for the current business period are settled in terms of various evaluation indices. Similarly, when the executive layer approves the amended budget, the budget values are also settled. Alternatively, when the amended budget is approved, a judgment maybe made as to whether the budget values of the amended budget are valid or not, so that the budget values can be settled only when the budget values are valid.

On the other hand, when a customer sends an order for a product to the corporation (step S24) this order is delivered to the site departments (step S25). The respective site departments, e.g. including a procurement department, a production department and a shipping department, execute business (step S26) to thereby deliver the product to the customer. At the same time, result values, which are obtained at the time of execution of business in the respective site departments in terms of evaluation indices the same as those for the budget values, are sent to the business improvement support system (step S27). The business improvement support system judges whether the result values are valid or not (step S28). The judgment mentioned herein is to judge whether or not the result values are comparatively widely different from the actual result values up to the previous business period to thereby check whether the result values have been input into the business improvement support system by mistake.

When the business improvement support system makes a decision that the result values are not valid (No in step S28) result values in the site departments are reacquired (step S29) On the other hand, if the business improvement support system makes a decision that the result values are valid (Yes in step S28), the budget values and the result values for the current business period are settled. Similarly, when valid result values are reacquired, the budget values and the result values are also settled.

On the other hand, the customer to whom the product was delivered is subjected to a customer satisfaction (hereinafter also referred to as CS) survey such as a questionnaire survey. When the customer gives an answer to a questionnaire of the CS survey (step S30), the answer is sent to the business improvement support system (step S31). This CS survey is performed by investigation into the levels of satisfaction concerned with respective evaluation indices such as KPIs.

The business improvement support system executes gap analysis to analyze the gap between the level of achievement obtained from each budget value and a result value and the level of customer satisfaction obtained as a result of the CS survey (step S32). That is, the business improvement support system analyzes the size of the gap between internal corporate evaluation and customer's evaluation in terms of each of the evaluation indices such as KPIs.

When the gap analysis clarifies the gap between the internal corporate evaluation and the customer's evaluation, a target value is obtained in such a manner that the budget value for the current business period is adjusted in accordance with each evaluation index in order to reduce the gap. Specifically, when the level of achievement in the corporation is higher than the level of customer satisfaction, a target value more difficult to reach than the budget value for the current business period is obtained because the budget value of performance is originally so low from the customer viewpoint that it is conceivable that the corporation overvalues its own ability to conduct business (operation capability). On the other hand, when the level of achievement in the corporation is lower than the level of customer satisfaction, a target value easier to reach than the budget value for the current business period is obtained because the budget for performance value is originally so high from the customer viewpoint that it is conceivable that the corporation undervalues its own ability to conduct business (operation capability).

When the target value is adjusted based on the result of the gap analysis, the business improvement support system performs micro analysis on the target value (step S33) to obtain itemized target values specific to the respective site departments from the target value concerned with evaluation indices such as KPIs, so that the business improvement support system sends the itemized target values to the site departments and the management department (step S34). While the site departments start up improvement activity toward the itemized target values respectively (step S35), the management department makes a budget plan for the next business period in accordance with the itemized target values (step S36).

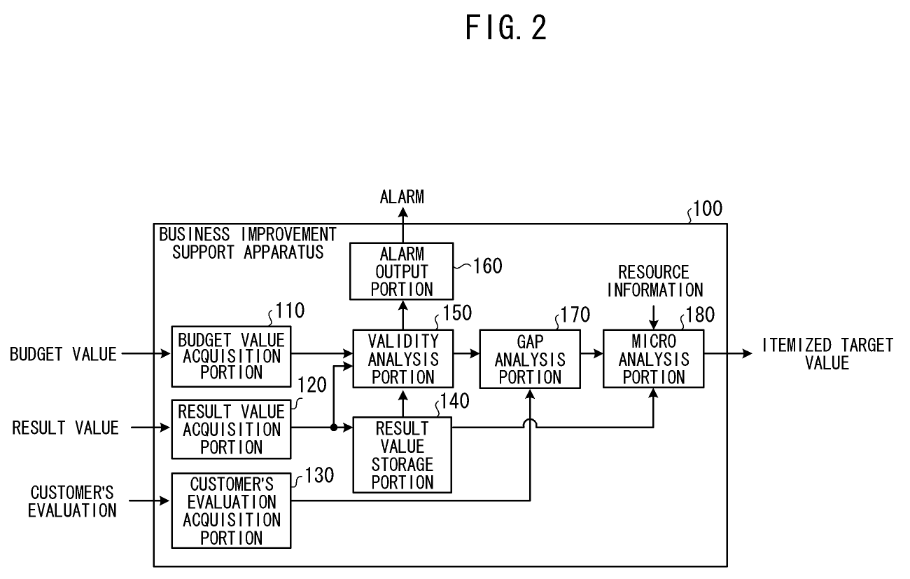

FIG. 2 is a block diagram showing the configuration of the main part of a business improvement support apparatus 100 installed in the business improvement support system according to this embodiment. The business improvement support apparatus 100 shown in FIG. 2 has a budget value acquisition portion 110, a result value acquisition portion 120, a customer's evaluation acquisition portion 130, a result value storage portion 140, a validity analysis portion 150, an alarm output portion 160, a gap analysis portion 170 and a micro analysis portion 180.

The budget value acquisition portion 110 acquires a budget value in accordance with each evaluation index in a budget plan made by the management department and decided by the executive layer. In addition, the budget value acquisition portion 110 acquires specific itemized budget values decided by the respective site departments based on the budget value in accordance with each evaluation index. Specifically, when, for example, a KPI “average lead time” is used as an evaluation index concerned with the delivery time of a product, the budget value acquisition portion 110 acquires a budget value of the average lead time. When the “average lead time” is departmentalized into items “procurement lead time”, “production lead time” and “shipping lead time” corresponding to the respective site departments in the corporation, the budget value acquisition portion 110 acquires itemized budget values in the respective site departments.

The result value acquisition portion 120 acquires itemized result values in business execution of the respective site departments. Specifically, when, for example, the KPI “average lead time” is departmentalized into items “procurement lead time”, “production lead time” and “shipping lead time”, the result value acquisition portion 120 acquires itemized result values from the site departments relevant to the lead times respectively.

Description will be made below on the case where the “average lead time” is set as a KPI concerned with the delivery time of a product, and the average lead time is departmentalized into items “procurement lead time”, “production lead time” and “shipping lead time” by way of example. These items can be set as desired by the corporation. The sum of the itemized lead times is equal to the average lead time.

The customer's evaluation acquisition portion 130 acquires customer evaluations of corporate business in accordance with each evaluation index after a product is delivered from the corporation to a customer who ordered the product. Specifically, the customer's evaluation acquisition portion 130 acquires a result of evaluation of customer satisfaction (e.g. in a five-level evaluation scale) concerned with the delivery time based on a customer's answer to a questionnaire. On this occasion, the customer's evaluation acquisition portion 130 acquires customer evaluations concerned with each KPI. Accordingly, in the aforementioned example, the customer's evaluation acquisition portion 130 acquires a result of evaluation of customer satisfaction concerned with the delivery time as an evaluation of the average lead time.

The result value storage portion 140 stores the itemized result values acquired by the result value acquisition portion 120. That is, since result values are acquired every predetermined period, the result value storage portion 140 stores past itemized result values.

The validity analysis portion 150 decides proper ranges of each budget value and each result value for the current business period from the past result values stored in the result value storage portion 140, and judges whether the budget value for the current business period acquired by the budget value acquisition portion 110 and the result value in the current business period acquired by the result value acquisition portion 120 are valid or not. That is, the validity analysis portion 150 uses a fitting function to approximate a time-series growth rate of the result value from the past result values, and calculates theoretical values of the budget and result values for the current business period based on the fitting function. The validity analysis portion 150 compares the theoretical values with the budget and result values for the current business period to thereby judge whether the budget and result values for the current business period are in realistic and reasonable ranges or not. The specific internal configuration of the validity analysis portion 150 will be described later.

The alarm output portion 160 outputs an alarm when the budget and result values are not valid as a result of judgment in the validity analysis portion 150 as to whether the budget and result values are valid or not. That is, when the budget and result values for the current business period are not realistic in consideration of a growth rate based on the past result values, the alarm output portion 160 outputs an alarm because there is a possibility of a fault in the budget plan or an input error in the budget and result values. That is, when the budget or result value is invalid, the alarm output portion 160 outputs an alarm to give a caution, for example, to an administrator or the like of the business improvement support apparatus 100.

When the validity analysis portion 150 makes a decision that the budget and result values are valid, the gap analysis portion 170 calculates the level of achievement in the current business period based on the budget and result values. The gap analysis portion 170 also calculates the level of customer satisfaction based on the customer's evaluation acquired by the customer's evaluation acquisition portion 130. The gap analysis portion 170 further calculates a gap between the level of achievement and the level of customer satisfaction, and outputs the calculated gap as gap information to the micro analysis portion 180. Specifically, when, for example, the level of achievement calculated based on the budget and result values is 95% and the level of customer satisfaction calculated based on the customer's evaluation is 60%, the gap analysis portion 170 outputs gap information expressing that the level of achievement is larger by 35% than the level of customer satisfaction, to the micro analysis portion 180. On this occasion, the gap analysis portion 170 calculates a difference between the level of achievement and the level of customer satisfaction in accordance with each KPI so that the level of achievement and the level of customer satisfaction can be compared with each other while treated in the same way. The specific internal configuration of the gap analysis portion 170 will be described later.

The micro analysis portion 180 adjusts the current-period budget value concerned with each KPI based on the gap information output from the gap analysis portion 170 and performs micro analysis on the next-period target value concerned with each KPI based on the adjustment of the budget value to thereby calculate next-period itemized target values concerned with items into which the KPI is departmentalized. Specifically, the micro analysis portion 180 uses an approximate function which expresses the relation between a resource quantity such as cost input to achieve satisfactory results in the past and a actual past itemized result value, and calculates itemized target values totaling up to the target value concerned with the KPI and a required resource quantity or the like to be input for achievement of the itemized target values, based on the obtained approximate function.

When, for example, a target value of the “average lead time” is adjusted to “8 days” as a result of gap analysis, the micro analysis portion 180 allocates “8 days” to the items “procurement lead time”, “production lead time” and “shipping lead time” so that the sum of the itemized target values becomes “8 days”. For allocation of “8 days” to the respective items, the micro analysis portion 180 calculates itemized target values while referring to resource information and taking the condition etc. of resources allocated to the respective items into consideration.

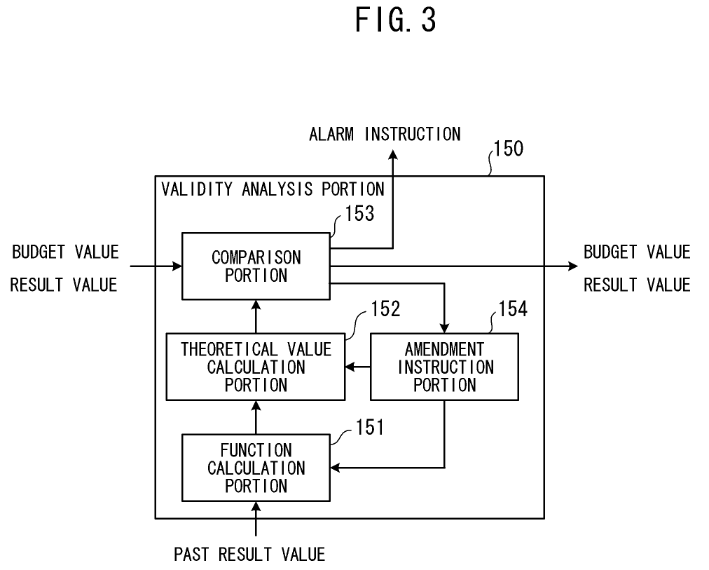

FIG. 3 is a block diagram showing the internal configuration of the validity analysis portion 150 according to this embodiment. The validity analysis portion 150 shown in FIG. 3 has a function calculation portion 151, a theoretical value calculation portion 152, a comparison portion 153, and an amendment instruction portion 154.

The function calculation portion 151 reads past itemized result values from the result value storage portion 140 and calculates a fitting function expressing change of the itemized result values with the passage of time, for example, by the method of least squares etc. The function calculation portion 151 holds the calculated fitting function. Upon reception of an instruction from the amendment instruction portion 154 to amend the fitting function, the function calculation portion 151 reads all itemized result values up to the previous period from the result value storage portion 140, and amends the held fitting function. To take a specific example, assume that the current business period is an (N+1)-th period and the function calculation portion 151 holds a fitting function for result values up to an (N−1)-th period. The function calculation portion 151 recalculates the fitting function while adding new result values in an N-th period to the result values up to the (N−1)-th period when there is an instruction given from the amendment instruction portion 154.

The theoretical value calculation portion 152 calculates theoretical result values in the current business period by using the fitting function held in the function calculation portion 151. The theoretical value calculation portion 152 also calculates a theoretical result value concerned with each KPI by adding up weighted itemized theoretical values multiplied by predetermined weights respectively. Further, upon reception of an instruction from the amendment instruction portion 154 to amend the weights, the theoretical value calculation portion 152 amends the weights by which the itemized theoretical values are multiplied.

The comparison portion 153 compares a budget value and itemized budget values in accordance with each KPI with a theoretical value and itemized theoretical values in accordance with the KPI calculated by the theoretical value calculation portion 152, to thereby judge whether the budget values for the current business period are in realistic and reasonable ranges or not. Similarly, the comparison portion 153 compares a result value and itemized result values in accordance with each KPI with a theoretical value and itemized theoretical values in accordance with the KPI calculated by the theoretical value calculation portion 152, to thereby judge whether the result values in the current business period are in realistic ranges or not. Specifically, the comparison portion 153 calculates a deviation of a budget or result value from a theoretical value and decides that the budget or result value is not realistic when the deviation is not smaller than a predetermined threshold. Alternatively, the comparison portion 153 may calculate an absolute value of the difference between the budget or result value and the theoretical value, and decide that the budget or result value is not realistic when the absolute value of the difference in the current business period is not smaller than the absolute value of the difference in the previous business period. When the comparison portion 153 decides that the budget or result value is realistic and valid, the comparison portion 153 outputs the budget or result value to the gap analysis portion 170.

In addition, when the comparison portion 153 decides that the budget or result value is not realistic, the comparison portion 153 instructs the amendment instruction portion 154 to look up the fitting function or the weights used for calculation of the theoretical values. When the comparison portion 153 decides again that the budget or result value is not realistic even after the comparison portion 153 instructs the amendment instruction portion 154 to look up the fitting function or the weights, the comparison portion 153 further instructs the alarm output portion 160 to output an alarm.

Upon reception of the instruction from the comparison portion 153 to look up the fitting function or the weights, the amendment instruction portion 154 instructs the function calculation portion 151 to amend the fitting function and instructs the theoretical value calculation portion 152 to amend the weights by which the itemized theoretical values are multiplied. Incidentally, the amendment instruction portion 154 may instruct both the function calculation portion 151 and the theoretical value calculation portion 152 to perform both amendments simultaneously, or may instruct either of the function calculation portion 151 and the theoretical value calculation portion 152 to perform only one amendment. In addition, the amendment instruction portion 154 may instruct either of the function calculation portion 151 and the theoretical value calculation portion 152 to amend an unamended fitting function or weights when the comparison portion 153 decides again that the budget or result value is not realistic after the amendment instruction portion 154 instructs either of the function calculation portion 151 and the theoretical value calculation portion 152 to perform only one amendment.

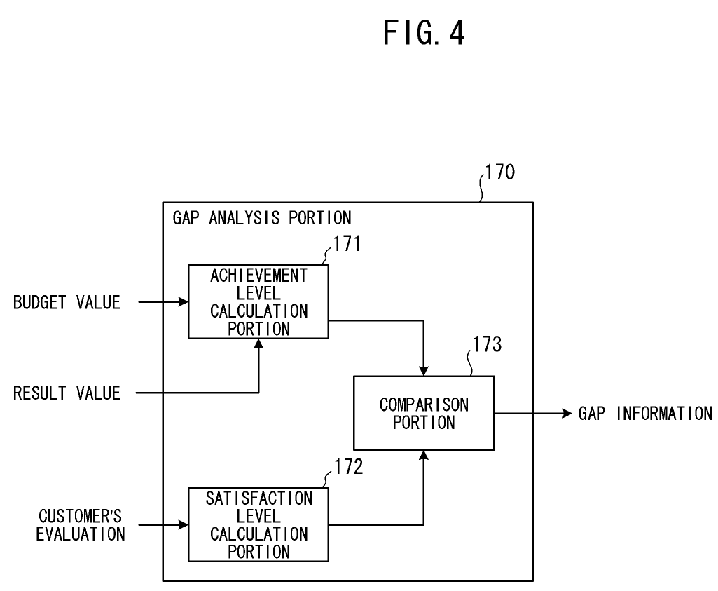

FIG. 4 is a block diagram showing the internal configuration of the gap analysis portion 170 according to this embodiment. The gap analysis portion 170 shown in FIG. 4 has an achievement level calculation portion 171, a satisfaction level calculation portion 172, and a comparison portion 173.

The achievement level calculation portion 171 calculates a ratio of a result value to a budget value as the level of achievement. Specifically, the achievement level calculation portion 171 calculates the level of achievement indicating the achievement ratio of a result value concerned with a KPI such as average lead time obtained at the end of a business period to a budget value concerned with the KPI made at the beginning of the business period. On this occasion, the achievement level calculation portion 171 calculates the KPI (e.g. average lead time) result value by adding up itemized result values concerned with items such as procurement lead time, production lead time and shipping lead time, and then calculates the achievement level. That is, the achievement level calculation portion 171 calculates achievement levels in accordance with the respective KPIs.

The satisfaction level calculation portion 172 calculates the level of customer satisfaction from customer's evaluation acquired by the customer's evaluation acquisition portion 130. Specifically, when an answer to a questionnaire in a five-level evaluation scale is acquired as evaluation, the satisfaction level calculation portion 172 calculates the level of customer satisfaction, for example, by digitalizing the customer's evaluation so that the level of customer satisfaction corresponding to an answer with the highest evaluation is regarded as 100% and the level of customer satisfaction corresponding to an answer with the second highest evaluation is regarded as 80%. Incidentally, when, for example, a dichotomous (alternative) questionnaire survey was performed on a plurality of customers, the satisfaction level calculation portion 172 may regard a ratio of the number of customers who gave a positive answer to the total number of surveyed customers as the level of customer satisfaction.

Incidentally, the achievement level calculation portion 171 and the satisfaction level calculation portion 172 calculate the level of achievement and the level of customer satisfaction respectively in accordance with each KPI. That is, when the achievement level calculation portion 171 calculates the level of achievement concerned with the average lead time, the satisfaction level calculation portion 172 calculates the level of customer satisfaction with the average lead time. Accordingly, the achievement level calculation portion 171 calculates the level of achievement while adding up itemized budget and result values in accordance with each KPI. Similarly, the satisfaction level calculation portion 172 calculates the level of customer satisfaction while adding up customer's evaluations such as results of the questionnaire survey in accordance with each KPI.

The comparison portion 173 compares the achievement level calculated by the achievement level calculation portion 171 and the customer satisfaction level calculated by the satisfaction level calculation portion 172, and outputs a difference between the achievement level and the customer satisfaction level as gap information to the micro analysis portion 180. Since the achievement level and the customer satisfaction level are calculated on the same basis of a KPI, the comparison portion 173 can compare the achievement level and the customer satisfaction level with each other while treating these levels in the same way, and output a difference between the achievement level and the customer satisfaction level as gap information. When a result of the comparison by the comparison portion 173 shows that the achievement level is higher than the customer satisfaction level, it is found that the criterion for self-evaluation of corporate ability (operation capability) to execute business is lower than the criterion for customer evaluation. On the other hand, when a result of the comparison shows that the achievement level is lower than the customer satisfaction level, it is found that the criterion for self-evaluation of corporate ability (operation capability) to execute business is higher than the criterion for customer evaluation.

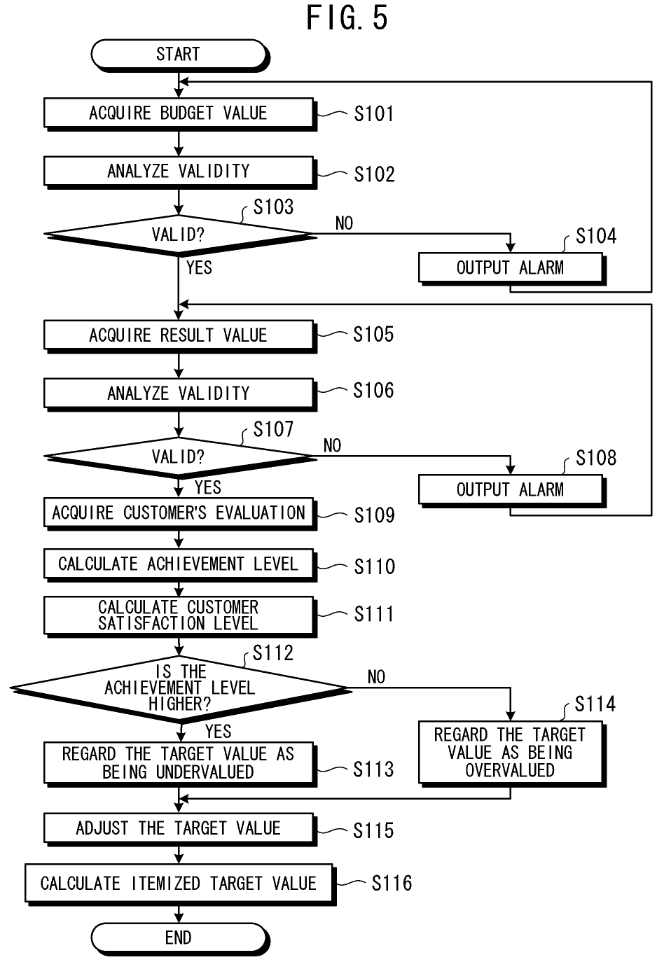

Operation of the business improvement support apparatus 100 configured as described above will be described below with reference to a flow chart shown in FIG. 5.

When each KPI budget value is decided by the management department of a corporation and itemized budget values are decided by the respective site departments of the corporation at the beginning of a predetermined business period such as a fiscal year, the budget value acquisition portion 110 of the business improvement support apparatus 100 acquires these budget values (step S101). These acquired budget values are output to the validity analysis portion 150, so that the validity analysis portion 150 performs validity analysis on these budget values (step S102). That is, the theoretical value calculation portion 152 of the validity analysis portion 150 calculates theoretical values and itemized theoretical values for the current-period result values in accordance with the respective KPIs by using a fitting function held in the function calculation portion 151, and the comparison portion 153 judges whether or not the budget values are in valid ranges based on the theoretical values for the current-period result values (step S103).

When the judgment comes to a conclusion that the budget values are not in valid ranges (No in step S103), the comparison portion 153 instructs the alarm output portion 160 to output an alarm (step S104). Incidentally, when these budget values are not in valid ranges, the fitting function or weights may be amended. That is, the amendment instruction portion 154 may instruct the function calculation portion 151 or the theoretical value calculation portion 152 to amend the fitting function or the weights respectively so that the function calculation portion 151 can recalculate the fitting function while adding the latest result values up to the previous business period, or the theoretical value calculation portion 152 can amend the weights by which the itemized result values are multiplied.

On the other hand, when the budget values are realistic and reasonable and in valid ranges (Yes in step S103), the budget values are set so that the respective site departments conduct business toward the goal of the budget values in this business period. That is, the respective site departments execute business activities such as procurement of parts of a product, production of the product and shipping of the product in accordance with an order from a customer. Then, the result value acquisition portion 120 acquires itemized result values from the respective site departments at the end of the business period (step S105). The result value acquisition portion 120 outputs these acquired result values to the validity analysis portion 150, so that the validity analysis portion 150 performs validity analysis on the result values (step S106). That is, the theoretical value calculation portion 152 of the validity analysis portion 150 calculates itemized theoretical values for the current-period result values by using the fitting function held in the function calculation portion 151, and the comparison portion 153 judges whether or not the result values are in valid ranges based on the theoretical values (step S107).

When the judgment is that the result values are not in valid ranges (No in step S107), the comparison portion 153 instructs the alarm output portion 160 to output an alarm (step S108). Incidentally, when the result values are not in valid ranges, the fitting function may be amended in the same manner as in the case of the validity analysis of the budget values.

On the other hand, when the result values are proper and in valid ranges (Yes in step S107), the result values are decided. As a result of business execution, evaluation of business given by a customer which is, for example, a destination of delivery of the product, is acquired by the customer's evaluation acquisition portion 130 (step S109). For example, the customer's evaluation is acquired as an answer to the questionnaire. The customer's evaluation is output to the satisfaction level calculation portion 172 of the gap analysis portion 170. The current-period budget and result values which are decided to be valid and then settled are output to the achievement level calculation portion 171 of the gap analysis portion 170.

The achievement level calculation portion 171 calculates the level of achievement in accordance with each KPI in the current business period based on the budget and result values (step S110). That is, for example, the achievement level calculation portion 171 calculates the degree of achievement of the budget value of the average lead time in this business period as the level of achievement by dividing the result value of the average lead time by the budget value of the average lead time. To take a specific example, assume that the budget value of the average lead time is 10 days and the result value thereof is 10.5 days. Then the level of achievement A is calculated by the following expression (1).

A=1−{(10.5 days−10 days)/10 days}×100=95% (1)

Incidentally, since the delivery time becomes shorter and the achievement level becomes higher as the value of the average lead time becomes smaller, the level of achievement A can be calculated by the above expression (1). As for another KPI such as a sales amount, since the level of achievement becomes higher as the value of the KPI becomes larger, the level of achievement can be calculated by simply dividing a result value by a budget value.

At the same time that the achievement level calculation portion 171 calculates the level of achievement, the satisfaction level calculation portion 172 calculates the level of customer satisfaction by digitizing customer's evaluation in accordance with each KPI (step S111). That is, the satisfaction level calculation portion 172 converts the customer's evaluation into a numeric value comparable to the level of achievement so that the level of customer satisfaction can be set at 100% when the answer to the questionnaire is the highest evaluation, for example, in a 5-level evaluation scale, and the level of customer satisfaction can be set at 80% when the answer to the questionnaire is the second highest evaluation. Incidentally, the satisfaction level calculation portion 172 may calculate the level of customer satisfaction by digitizing customer evaluations by using statistical processing or the like. That is, when, for example, a questionnaire survey on a plurality of customers makes them select the alternative of “satisfied” or “unsatisfied”, the ratio of the number of customers having answered “satisfied” to the total number of customers having responded to the questionnaire may be regarded as the level of customer satisfaction.

The comparison portion 173 compares the level of achievement and the level of customer satisfaction concerned with the same KPI with each other (step S112) and outputs a difference between the level of achievement and the level of customer satisfaction as gap information to the micro analysis portion 180. When the level of achievement is higher than the level of customer satisfaction on this occasion (Yes in step S112), it is found that the customer's evaluation is severer than the corporate self-evaluation, and that the budget value targeted for the current business period by the corporation was too low from the viewpoint of the level of customer satisfaction (step S113). Accordingly, it is necessary to set a next-period target value to be higher than the current-period budget value in order to reduce the gap between the level of achievement and the level of customer satisfaction.

Similarly, when the level of achievement is lower than the level of customer satisfaction (No in step S112), it is found that the corporate self-evaluation is severer than the customer's evaluation, and that the budget value targeted for the current business period by the corporation was too high from the viewpoint of the level of customer satisfaction (step S114). Accordingly, it is necessary to set a next-period target value to be lower than the current-period budget value in order to reduce the gap between the level of achievement and the level of customer satisfaction.

The micro analysis portion 180 adjusts the current-period budget value of each KPI in accordance with the gap information and sets the adjusted budget value as a next-period target value of the KPI (step S115). That is, when the gap information expresses that the level of achievement is higher than the level of customer satisfaction, the micro analysis portion 180 increases the current-period budget value and sets the increased budget value as the next-period target value. On the other hand, when the gap information expresses that the level of customer satisfaction is higher than the level of achievement, the micro analysis portion 180 reduces the current-period budget value and sets the reduced budget value as the next-period target value.

The micro analysis portion 180 performs micro analysis on the next-period target value of the KPI to calculate next-period itemized target values (step S116). Specifically, the micro analysis portion 180 obtains an approximate function of result values with respect to resource quantities based on resource information about itemized resources input in the respective periods and the itemized result values stored in the result value storage portion 140. Then, the micro analysis portion 180 calculates next-period itemized target values, necessary resource quantities etc. by applying conditions etc. of the current-period itemized result values and resources to be input in the next period for the respective items to the approximate function.

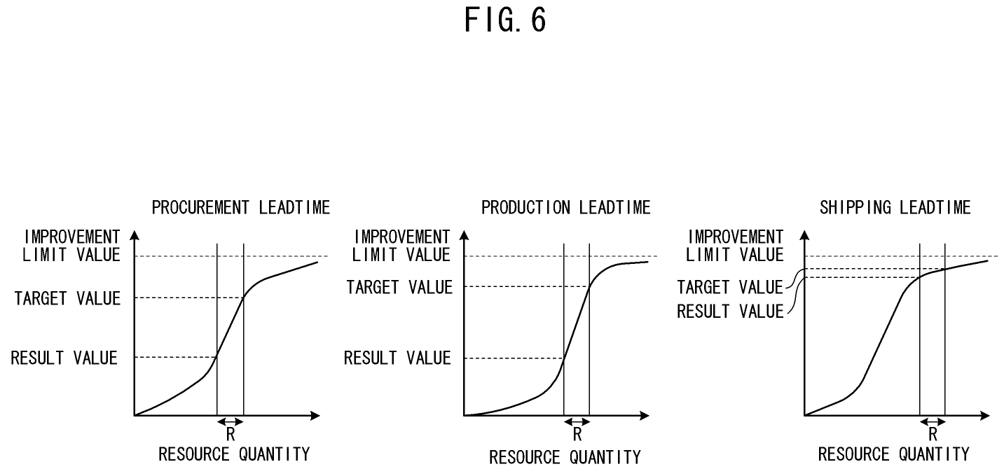

Specifically, after the next-period target value of the average lead time is adjusted in accordance with the gap information, the micro analysis portion 180 allocates the target value of average lead time to target values of procurement lead time, production lead time and shipping lead time, for example, as shown in FIG. 6. In the example shown in FIG. 6, an approximate function expressing the relation between an input resource quantity and a result value is obtained with respect to each of procurement lead time, production lead time and shipping lead time so that respective itemized target values the sum of which is equal to the target value of average lead time are decided such that each resource quantity which will be input in the next business period is fixed to R. That is, although the next-period itemized target values are decided when the fixed resource quantity R is input to each current-period itemized result value, the resource quantity R is set so that the sum of these target values is equal to the target value of the average lead time.

As described above, since the next-period itemized target values and the necessary resource quantities are decided by use of the approximate functions between the itemized resource quantities and the result values to satisfy the next-period target value of average lead time, it is possible to decide on specific target values for reduction of the gap between the level of achievement and the level of customer satisfaction. Incidentally, although the description of FIG. 6 has been made on the assumption that the resource quantities and the itemized target values are decided under the condition that the resource quantities to be input to the respective items are equal to one another, the resource quantities and the itemized target values can be determined in accordance with various conditions. When, for example, a condition is imposed so that differences between the target values and the current-period result values will become numeric values close to one another for the respective items to improve the respective items uniformly, or the total resource quantity to be input will become smallest, the itemized target values and the necessary resource quantities can be calculated in various patterns.

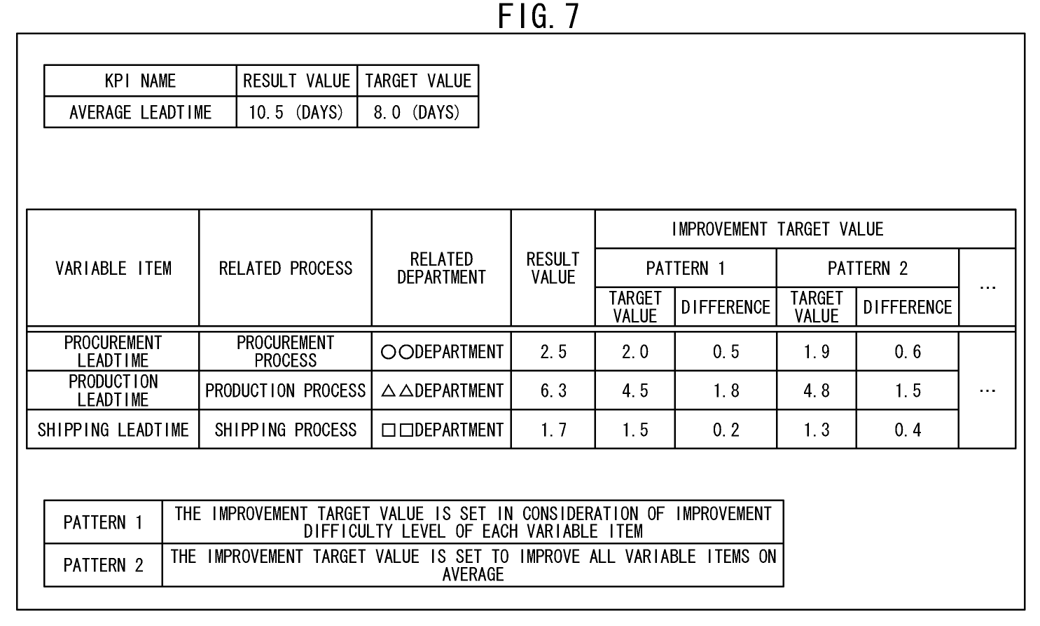

A result of micro analysis by the micro analysis portion 180 is displayed on displays (not shown) etc. of the business improvement support apparatus 100, the respective site departments and the management department, so that the respective departments can grasp the next-period itemized target values. That is, for example, as shown in FIG. 7, a current-period KPI result value (10.5 days) and a target value (8 days) adjusted as a result of the gap analysis are displayed and results of allocation of the KPI target value to the respective items in accordance with various patterns are displayed. In the example shown in FIG. 7, a pattern 1 shows itemized target values obtained in consideration of improvement difficulty levels of the respective items and a pattern 2 shows itemized target values obtained under a condition that all the items are improved uniformly. In any one of the patterns, the sum of the itemized target values is 8 days to be equal to the KPI target value.

As described above, in this embodiment, a gap between the level of achievement in the corporation and the level of customer satisfaction is detected. When the gap is detected, a KPI target value is adjusted to reduce the gap. The KPI target value is allocated to more specific itemized target values, so that the respective site departments promote business improvement toward the itemized target values respectively.

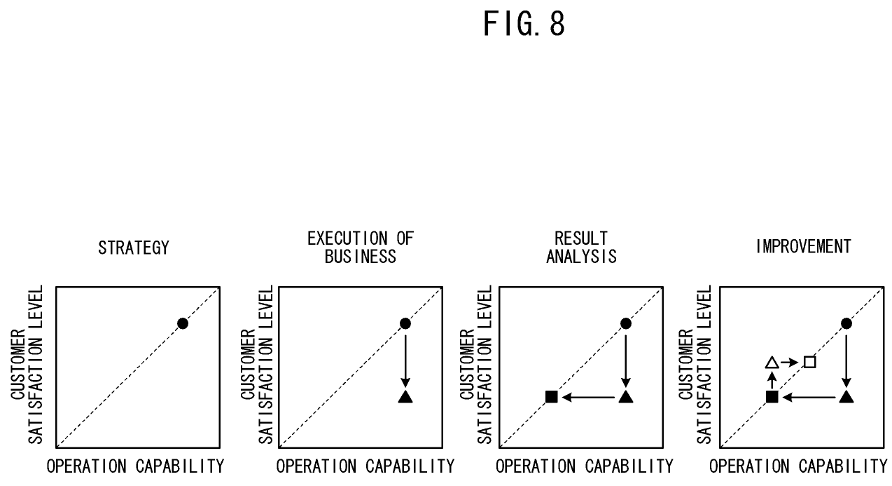

On this occasion, the gaps detected by the gap analysis portion 170 are classified into two gap groups, i.e. a gap group in the case where the level of achievement is higher than the level of customer satisfaction and a gap group in the case where the level of achievement is lower than the level of customer satisfaction. In a corporation having the former gap, for example, as shown in FIG. 8, it is assumed that both operation capability and customer satisfaction level are relatively high (in a black circle position in FIG. 8) in a strategy forming stage, but it is found that the customer satisfaction level is lower (in a black triangle position in FIG. 8) than the assumed customer satisfaction level when the customer satisfaction level is actually surveyed based on execution of business.

Since there is a gap between the achievement level and the customer satisfaction level as described above, it is recognized from result analysis that the real operation capability and customer satisfaction level are lower (in a black square position in FIG. 8) than the assumed operation capability and customer satisfaction level. In this stage, the KPI target value is adjusted and micro analysis is performed on the target value so that the respective site departments can then promote business improvement. As a result, the customer satisfaction level is improved (to a white triangle position in FIG. 8) and the operation capability is really improved (to a white square position in FIG. 8). When this process is repeated, the corporate operation capability and the customer satisfaction level are improved to prevent the criterion for corporate self-evaluation from becoming egotistic. Accordingly, subjective evaluation of corporate activities can be removed to support business improvement adapted to market environment.

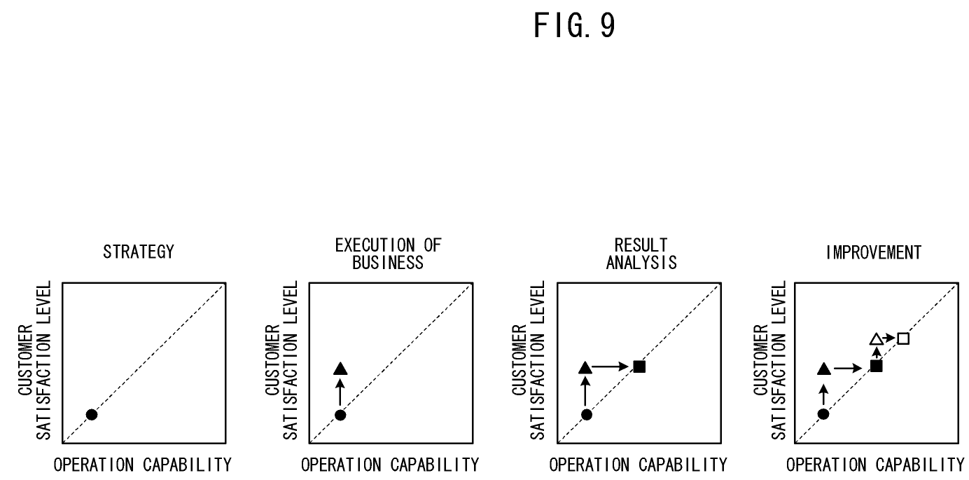

On the other hand, in a corporation having the latter gap in the case where the achievement level is lower than the customer satisfaction level, for example, as shown in FIG. 9, it is assumed that both operation capability and customer satisfaction level are relatively low (in a black circle position in FIG. 9) in a strategy forming stage, but it is found that the customer satisfaction level is higher (in a black triangle position in FIG. 9) than the assumed customer satisfaction level when the customer satisfaction level is really surveyed based on performance of the business.

Since there is a gap between the achievement level and the customer satisfaction level as described above, it is recognized from result analysis that the real operation capability and customer satisfaction level are higher (in a black square position in FIG. 9) than the assumed operation capability and customer satisfaction level. In this stage, the KPI target value is adjusted and micro analysis is performed on the target value so that the respective site departments can then promote business improvement. As a result, the customer satisfaction level is improved (to a white triangle position in FIG. 9) and the operation capability is really improved (to a white square position in FIG. 9). When this process is repeated, the corporate operation capability and the customer satisfaction level are improved to prevent the criterion for corporate self-evaluation from becoming unreasonably severe. Accordingly, subjective evaluation of corporate activities can be removed to support business improvement adapted to market environment.

As described above, according to this embodiment, while the level of achievement in a corporation is calculated based on current-period budget and result values with respect to the same evaluation index, the level of customer satisfaction is calculated based on customer evaluations to thereby detect a gap between the level of achievement and the level of customer satisfaction. A next-period target value is adjusted to reduce the gap and the target value of the evaluation index is further allocated to specific items to decide respective itemized target values. Accordingly, corporate self-evaluation and customer evaluations can be prevented from contradicting each other, so that a customer viewpoint can be put in place to fill a deficit in subjective evaluation of corporate activities, to thereby support business improvement adapted to market environment.

### Second Embodiment

Embodiment 2 of the invention is characterized in that prime customers high in profit, occupancy rate or sales amount, and relatively high in the level of customer satisfaction, are extracted so that resources can be preferentially allocated to the prime customers to give favorable treatment to the prime customers when a next-period target value is calculated.

Since the business flow and configuration of a business improvement support apparatus according to this embodiment are the same as the business flow (FIG. 1) and configuration of the business improvement support apparatus 100 (FIG. 2) according to Embodiment 1, description thereof will be omitted. This embodiment is different from Embodiment 1 in the internal configuration of the gap analysis portion 170.

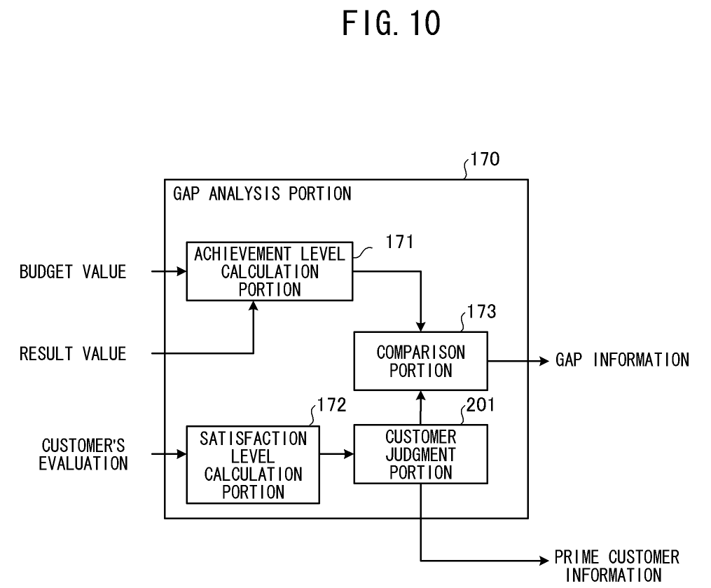

FIG. 10 is a block diagram showing the internal configuration of the gap analysis portion 170 according to this embodiment. In FIG. 10, parts the same as those in FIG. 4 are designated by the same reference numerals and description thereof will be omitted. The gap analysis portion 170 shown in FIG. 10 has an achievement level calculation portion 171, a satisfaction level calculation portion 172, a comparison portion 173, and a customer discrimination portion 201.

After the satisfaction level calculation portion 172 calculates each customer satisfaction level, the customer discrimination portion 201 discriminates, as a prime customer, a customer who has a profit, occupancy rate and a sales amount not smaller than predetermined thresholds respectively on a customer basis, and who has a customer satisfaction level not smaller than an average satisfaction level of plural customers. The customer discrimination portion 201 outputs prime customer information to the micro analysis portion 180 so that the prime customers can be identified. Incidentally, also in this embodiment, the comparison portion 173 compares the level of achievement and the level of customer satisfaction with each other and outputs gap information to the micro analysis portion 180 regardless of whether the customer is a prime customer or not.

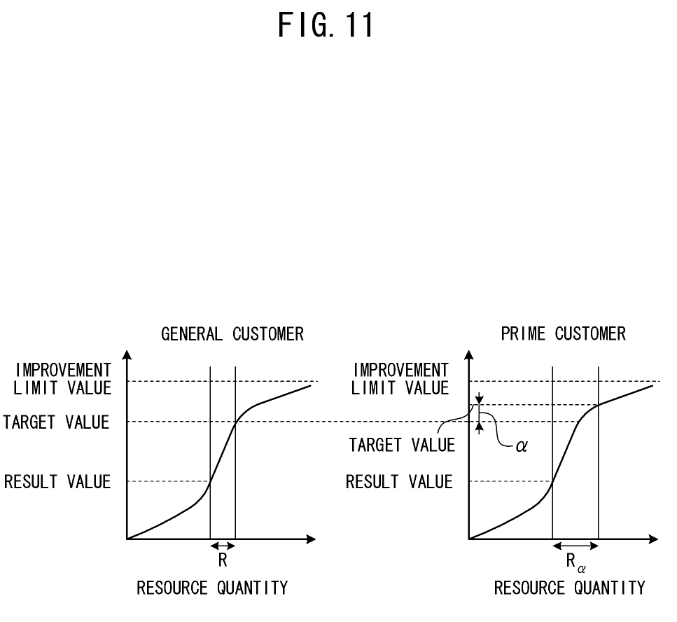

In this embodiment, since the prime customer who contributes to the sales of the corporation and who gives relatively high evaluation on business of the corporation is extracted, more resources are preferentially input to the prime customer compared with the general customers, and each next-period target value for the prime customer is treated preferentially at the time of micro analysis in the micro analysis portion 180. Specifically, for example, as shown in FIG. 11, a target value for the prime customer is larger by a than a target value for a general customer even when both the target values are for the same item. A resource quantity Ra larger than R is input for the prime customer while a resource quantity R is input for the general customer. Thus, business for the prime customer is improved preferentially compared with business for the general customer, so that it is possible to achieve business improvement in which favorable treatment is given to the prime customer, so that the corporation can compete successfully with other corporations.

Incidentally, in FIG. 11, when the target value for a prime customer becomes larger by a, the sum of itemized target values for the prime customer also becomes larger by a. On this occasion, the sum of the itemized target values for the prime customer exceeds a KPI target value. Therefore, after the target value for the prime customer is increased by a, a value obtained by dividing a by the number of customers is subtracted from each of the target values of all customers including the prime customer to thereby obtain each final target value. In this manner, the sum of itemized target values can be made equal to the KPI target value while the prime customer is treated preferentially.

As described above, in accordance with this embodiment, a prime customer who contributes to corporate sales and who gives comparatively high evaluation on corporate business is isolated so that more resources are input to the prime customer compared with the general customer to increase a target value for the prime customer. For this reason, the customer satisfaction level of the prime customer can be treated preferentially to improve competitiveness with other corporations, so that efficient business improvement can be achieved with no waste.

Incidentally, although the respective embodiments have been described on the assumption that analysis of the gap between the achievement level and the customer satisfaction level and micro analysis of the target value are executed by the business improvement support apparatus, the invention can be carried out on the case where the aforementioned processing is written as a computer-readable program and the program is executed by a computer.

This program may be recorded in a computer-readable medium so that this program can be executed by a computer. Examples of the computer include a host apparatus such as a personal computer, a controller of a testing apparatus, and a controller (such as an MPU or CPU) of a storage device. Examples of the computer-readable medium include a portable storage medium such as a CD-ROM, a flexible disc, a DVD disc, a magneto-optical disc or an IC card, a database for holding a computer program or another computer and its database, and a transmission medium on line.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of embodiments of the invention. Although the embodiment of the present invention has been described in detail, it should be understood that the various changes, substitutions, and alterations could be made hereto without departing from the spirit and scope of the invention.

What is claimed is:

1. A business improvement support apparatus comprising:
an achievement level calculation unit which calculates an achievement level in accordance with each of a plurality of evaluation indexes with respect to business in a predetermined period;
a satisfaction level calculation unit which calculates a customer satisfaction level with respect to the same evaluation index as the evaluation index in accordance with which the achievement level is calculated by the achievement level calculation unit;
a detection unit which detects a gap between the achievement level calculated by the achievement level calculation unit and the customer satisfaction level calculated by the satisfaction level calculation unit; and
a decision unit which sets a target value in accordance with the evaluation index corresponding to the gap detected by the detection unit, and decides specific itemized target values relevant to the evaluation index from the target values set in accordance with the evaluation index.

2. A business improvement support apparatus according to claim 1, wherein the achievement level calculation unit calculates, as an achievement level, a ratio of a result value at the end of a current period to a target value set at the beginning of the current period.

3. A business improvement support apparatus according to claim 2, wherein:
the achievement level calculation unit includes a judgment unit which judges whether the target and result values are valid or not; and
the achievement level calculation unit calculates an achievement level based on the target and result values when the judgment unit makes a decision that the target and result values are valid.

4. A business improvement support apparatus according to claim 3, wherein the judgment unit includes:
a function calculation unit which calculates a fitting function adapted to time-series change of the result value by using past result values;
a theoretical value calculation unit which calculates a theoretical result value in the current period by using the fitting function calculated by the function calculation unit; and
a comparison unit which compares the target or result value with the theoretical value calculated by the theoretical value calculation unit to thereby judge whether the target or result value is proper or not.

5. A business improvement support apparatus according to claim 1, wherein the detection unit detects, as a gap, a difference between the achievement level expressed in numeric value and the customer satisfaction level expressed in numeric value.

6. A business improvement support apparatus according to claim 1, wherein the decision unit sets a target value of an evaluation index to be higher than a target value of the evaluation index in a previous period when a gap expressing that the achievement level is higher than the customer satisfaction level is detected by the detection unit.

7. A business improvement support apparatus according to claim 1, wherein the decision unit obtains an approximate function expressing the relation between resource quantities input to specific business items in the past and past itemized result values, and decides specific itemized target values by using the obtained approximate function so that the sum of the specific itemized target values becomes equal to a target value of each evaluation index.

8. A business improvement support apparatus according to claim 1, further comprising a discrimination unit which identifies a prime customer whose customer satisfaction level calculated by the satisfaction level calculation unit is not lower than a predetermined level, wherein the decision unit sets a target value of each evaluation index for the prime customer discriminated by the discrimination unit so that the target value is higher than that of any other general customer.

9. A computer-readable recording medium with a business improvement support program stored therein, said program making a computer perform a business improvement supporting process comprising:
an achievement level calculating process for calculating an achievement level in accordance with each evaluation index with respect to business in a predetermined period;
a satisfaction level calculating process for calculating a customer satisfaction level with respect to the same evaluation index as the evaluation index in accordance with which the achievement level is calculated by the achievement level calculating process;
a detecting process for detecting a gap between the achievement level calculated by the achievement level calculating process and the customer satisfaction level calculated by the satisfaction level calculating process; and
a deciding process for setting a target value in accordance with the evaluation index correspondingly to the gap detected by the detecting process, and deciding on specific itemized target values relevant to the evaluation index from the target values set in accordance with the evaluation index.

10. A computer-readable recording medium with a business improvement support program stored therein according to claim 9, wherein the achievement level calculating process calculates, as an achievement level, a ratio of a result value at the end of a current period to a target value set at the beginning of the current period.

11. A computer-readable recording medium with a business improvement support program stored therein according to claim 10, wherein:
the achievement level calculating process includes a judging process for judging whether the target and result values are valid or not; and
the achievement level calculating process calculates an achievement level based on the target and result values when the judging process makes a decision that the target and result values are valid.

12. A computer-readable recording medium with a business improvement support program stored therein according to claim 11, wherein the judging process includes processes of:
a function calculating process for calculating a fitting function adapted to time-series change of the result value by using past result values;
a theoretical value calculating process for calculating a theoretical result value in the current period by using the fitting function calculated by the function calculating process; and
a comparing process for comparing the target or result value with the theoretical value calculated by the theoretical value calculating process to thereby judge whether the target or result value is proper or not.

13. A computer-readable recording medium with a business improvement support program stored therein according to claim 9, wherein the detecting process detects, as a gap, a difference between the achievement level expressed in numeric value and the customer satisfaction level expressed in numeric value.

14. A computer-readable recording medium with a business improvement support program stored therein according to claim 9, wherein the deciding process sets a target value of an evaluation index to be higher than a target value of the evaluation index in a previous period when a gap expressing that the achievement level is higher than the customer satisfaction level is detected by the detection step.

15. A computer-readable recording medium with a business improvement support program stored therein according to claim 9, wherein the deciding process obtains an approximate function expressing the relation between resource quantities input to specific business items in the past and past itemized result values, and decides specific itemized target values by using the obtained approximate function so that the sum of the specific itemized target values becomes equal to a target value of each evaluation index.

16. A computer-readable recording medium with a business improvement support program stored therein according to claim 9, further comprising a process for identifying a prime customer whose customer satisfaction level calculated by the satisfaction level calculating step is not lower than a predetermined level, wherein the deciding process sets a target value of each evaluation index for the prime customer identified by the discriminating process so that the target value is higher than that of any other general customer.
